(19) United States
(12) Patent Application Publication
(10) Pub. No.: US 2003/0165663 A1
(43) Pub. Date: Sep. 4, 2003

(54) Polymeric films and packages produced therefrom

(76) Inventors: Roy Christopherson, Shrivenham (GB); Stephen Summers, Portishead (GB)

Correspondence Address: BLANK ROME COMISKY & MCCAULEY, LLP, 900 17TH STREET, N.W., SUITE 1000, WASHINGTON, DC, 20006, US

(21) Appl. No.: 10/375,089

(22) Filed: Feb. 28, 2003

(30) Foreign Application Priority Data
Mar. 4, 2002 (GB) GB0204946.8

(51) Int. Cl. B32B 3/10

(52) U.S. Cl. 428/137; 428/212

(57) ABSTRACT

A gas permeable polymeric film laminate comprising two perforate polymeric films bonded together such that there are gas passages between the films from perforations in one film to perforations in the other film, the perforations having a minimum dimension of at least 20 μm and the passages having a maximum dimension of not more than 15 μm. Such films can be used as replacements for non-woven webs in packages consisting of a non-woven web bonded to substantially impermeable polymer webs, thereby avoiding fiber contamination which can occur with the latter.

### BACKGROUND TO THE INVENTION

This invention concerns polymeric films and packages produced therefrom, and more particularly for producing packages for medical equipment.

A widely used form of package for disposable or reusable items of medical equipment, for example gloves, sutures, syringes, scalpels, prostheses and the like, consists of a substantially impermeable polymer web bonded to a permeable non-woven web, preferably by a peelable seal. Such packages have gained wide acceptance because they are relatively easy and inexpensive to manufacture, their contents are easily accessible, and their contents are readily sterilised for example using a sterilant gas such as ethylene oxide which can pass through the permeable non-woven web.

Depending on the equipment to be packaged, the substantially impermeable polymer web used to form such packages can be a flat or shaped polymer sheet, the materials used to form the web generally being selected to contain the packaged contents without opening undesirably, for example in transit, and to bond to the non-woven web with a-peelable seal.

The non-woven web, which hitherto has typically been formed from cellulose or polyalkene fibers, has to be permeable in order to allow a sterilant gas to enter. However, it should not be sufficiently permeable to allow pathogenic organisms to enter, this generally requiring the webs to be impermeable to particles with a dimension of 20 μm or more.

This can be achieved using special grades of paper or sheets of non-woven polyalkene fibers. However, such materials are not without their problems, and in particular their tendency to release fibers from the webs when the webs are peeled from the substantially impermeable polymer web. The result can be undesirable contamination of the packaged equipment with fibers from the package.

The problem of fiber contamination can be avoided by the use of polymeric films having apertures or holes of less than 20 μm therein in place of the non-woven web. However, forming such small holes in the films presents problems as it usually requires expensive techniques, for example using lasers, and this tends to be exacerbated by the large number of apertures required to impart the required degree of permeability to effect sterilising of the contents of the package using a sterilant gas. Hot wires can be used to create large numbers of apertures per unit area of a film, but unfortunately they tend to produce apertures with a diameter of 20 μm or more and the resulting films would be unacceptable replacements for non-woven webs even though they avoid the problem of fiber release from the latter.

Furthermore, even if it were relatively easy to perforate films to provide them with apertures with a diameter of less than 20 μm, the numbers of apertures required to provide otherwise impermeable films with permeabilities comparable to those of paper would require impracticably large numbers of apertures. Thus in order to achieve an air transmission rate of 100 Bendtsen (ISO5636-3) with 10 μm diameter holes in a polyolefin film which is 100 μm thick would require 1.2×10⁷ holes/m², which is equivalent to 3.5×10³ holes per linear metre or one hole every 0.29 mm in along the length of the film and perpendicular thereto.

Smaller holes would require even larger numbers of holes to achieve the same permeability, for example 1.2×10¹¹ holes/m² of 1 μm diameter.

Clearly fewer larger holes would be required, for example 1.2×10³ holes/m² of 100 μm diameter being required to produce the same air permeability through the same film, this being equivalent to 35 holes per linear metre. It is clearly practicable to produce this number of holes, and thereby the air permeability required, but the holes themselves are too large to prevent bacteria from passing through the films.

As a result, non-woven materials have continued to be used for the packaging of medical equipment despite the problems referred to above.

### BRIEF SUMMARY OF THE INVENTION

According to the present invention there is provided a gas permeable polymeric film laminate comprising two perforate polymeric films bonded together such that there are gas passages between the films from perforations in one film to perforations in the other film, the perforations having a minimum dimension of at least 20 μm and the passages having a maximum dimension of not more than 15 μm.

The present invention further provides packages comprising a laminate in accordance with the present invention bonded to a substantially impermeable polymer web.

Laminates in accordance with the present invention can be used as replacements for non-woven webs in packages of the type previously described, and since they are not made from fibers, the problem of fiber contamination with prior art packages is avoided.

The perforations in the films used to form laminates in accordance with the present invention preferably have a maximum dimension of not more than 2000 μm, a preferred range of sizes being from 100 to 1000 μm.

The perforations in the two films are preferably substantially circular, and they can be formed using known methods, for example using pins, hot wires or a flame within a chilled perforated roller.

The respective numbers of perforations per unit area in the two films will depend on the air permeability required for the laminate and the size of the perforations which are to be used. Bearing in mind that the air permeability of films having circular holes is believed to be proportional to the fourth power of the hole diameter, relatively minor changes in the diameter of the holes in the films have a dramatic effect on the number of holes required to achieve a particular permeability, the latter being apparent from the data given in the above introduction. The size and number of apertures in the two films will therefore in general be selected to provide each film with a permeability which is at least the minimum desired for the laminate. Thus the apertures will usually have a minimum dimension perpendicular to the thickness of the film of at least 20 μm, more preferably at least 50 μm, and most preferably at least 100 μm. In general, however, it will not usually be necessary to use apertures with a minimum dimension of more than 500 μm.

The apertures can have a variety of cross sections, but circular holes are in general preferred due to their ease of production.

The number of apertures per unit area in each film used to produce laminates of the present invention should be sufficient to provide them both with an air permeability which is at least that required of laminates produced therefrom. It is also generally preferred that the apertures in films used to produce laminates in accordance should not be the controlling factor in determining the air permeability of the laminates.

The numbers of apertures per unit area in the two films can be the same or different. However, for reasons which will become apparent, it is generally preferred that the films used to produce laminates in accordance with the present invention have apertures disposed over their respective surfaces which do not align with apertures in the other film.

The passages between the two films will in general be used not only to prevent the passage of bacteria from one side of the laminates to the other, but also to control the air permeability of the laminates. These passages preferably have a maximum dimension of not more than 10 μm. However, their minimum dimension is preferably 5 μm.

The air permeability of laminates in accordance with the present invention is preferably at least 10 Bendtsen (ISO 9932:1990), and more preferably from 50 to 400 Bendtsen.

The films used to form laminates in accordance with the present invention can be selected from a wide variety of polymer types, for example they can be polyolefin based films, e.g. based on ethylene and/or propylene and/or butene-1; polyester films, e.g. based on polyethylene terephthalate; or polyamide films, e.g. containing a layer or layers of nylon. Such films can be coextruded and/or oriented. In addition, they can be selected independently of each other, thereby enabling one surface of the laminate to be selected to take advantage of the materials used to form the films. However, it is generally preferred that one of the films is selected to form a peelable seal to the substantially non-permeable polymer web of packages in accordance with the present invention.

Lamination of the polymeric films forming laminates of the present invention can be effected using an appropriate laminating adhesive for the films concerned, and the distance between the films in the laminate will in general be determined by the amount of laminating adhesive which is used.

The required passages between the films are preferably produced using a pattern of laminating adhesive which allows gas to flow through perforations in one film, through the passages and then through perforations in the other film. The pattern used is usually unimportant, but it is generally preferred that the resulting passages are not excessively long and/or tortuous as this could have an adverse effect on the permeability of the laminates. As will also be appreciated, pressure on the laminate can result in at least partial closure of the passages between the films, and the resulting effect on the permeability of the laminate will often depend on the number, shape and length of the passages.

Laminates in accordance with the present invention preferably have thicknesses of from 20 to 300 μm, and more preferably from 75 to 200 μm.

The films used to form laminates in accordance with the present invention preferably have thicknesses of from 10 to 150 μm, and more preferably from 35 to 100 μm, and they can be of substantially the same as or of different thicknesses from each other.

As will also be appreciated, although the films used to form laminates of the present invention can be selected widely from known polymeric films, and the laminating adhesive can also be similarly selected from known laminating adhesives, it is generally preferred that the adhesive provides the laminates with sufficient cohesive strength that when used to form peelable packages in accordance with the present invention, they peel from the web to which they have been bonded rather than delaminate internally.

### BRIEF DESCRIPTION OF THE DRAWINGS

An embodiment of laminate in accordance with the present invention will now be described with reference to the accompanying drawings in which:—

FIG. 1 shows a plan view of a portion of the laminate;

FIG. 2 shows a section on line A-A of FIG. 1; and

FIG. 3 shows a section on line B-B of FIG. 1.

### DETAILED DESCRIPTION OF THE DRAWINGS

The drawings, which are not to scale, show two substantially identical polymeric films 1 and 2 laminated together by strips of a laminating adhesive 3.

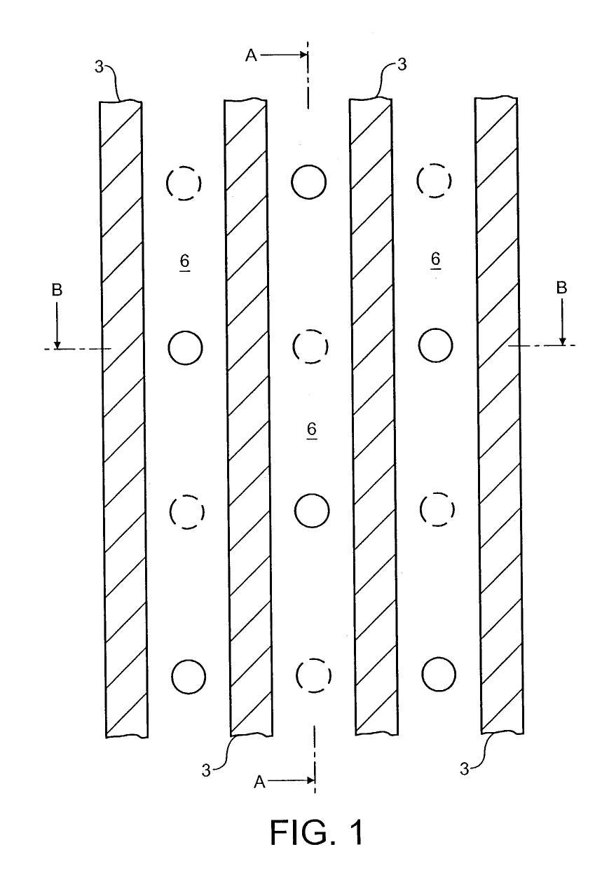

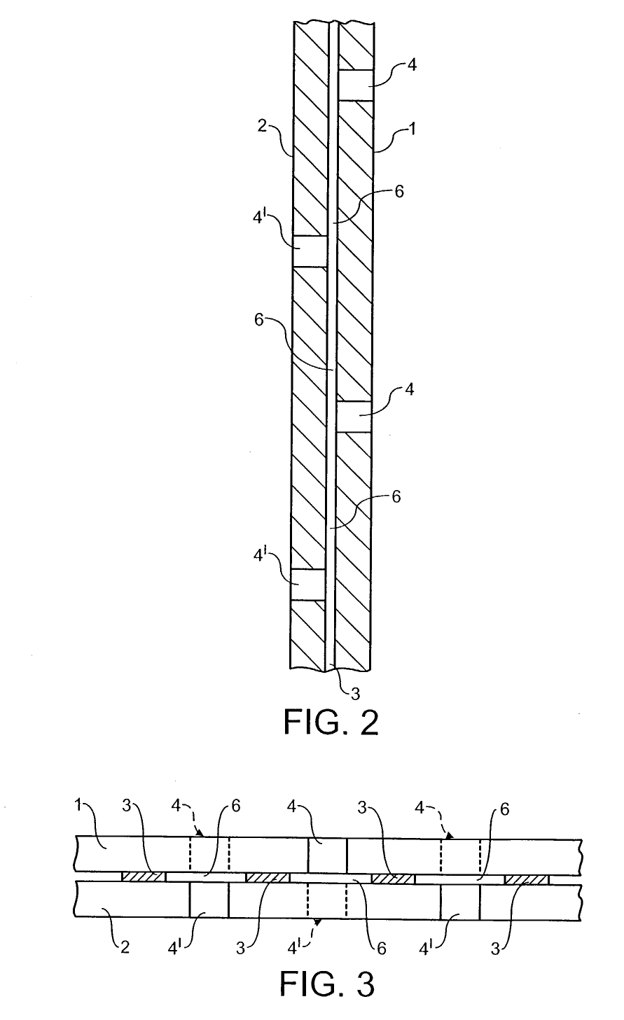

Both films 1 and 2 have rows of apertures or perforations 4 and 4′, for example each with a diameter of 50 μm, the perforations 4 shown as continuous lines in the upper film in FIG. 1 being staggered with respect to the perforations 4′ in the lower film.

The laminating adhesive 3 maintains the films 1 and 2 in spaced relationship to each other, the distance between the films being such that bacteria entering the perforations 4 cannot pass through the channels 6 between perforations 4 in film 1 and perforations 4′ in film 2, for example about 5 μm. However, air and/or sterilant gases can pass through the perforations 4 into the channels 6 and out of the perforations 4′, and by a suitable choice of size and number of perforations 4 and 4′ per unit area the permeability of the laminate can be made to be comparable to that of non-woven webs used hitherto for medical packaging.

The illustrated laminate uses parallel lines of adhesive 3 to maintain the films 1 and 2 in spaced relationship, thereby forming the channels 6. However, it will be appreciated that other patterns of adhesive can be used to perform a substantially similar function whereby bacteria are prevented from passing from perforations 4 in film 1 through the space between the films 1 and 2 to the perforations 4′ in the film 2. Furthermore, whilst in the illustrated laminate the distance between the films 1 and 2 is sufficiently small to prevent bacteria from passing therethrough, the laminating adhesive could be used additionally or alternatively for the purpose. For example, the laminating adhesive could be disposed between the films 1 and 2 so that they are spaced apart by the adhesive by more than 15 μm, the pattern of adhesive between the films 1 and 2 then being used to prevent bacteria passing through the pattern by a suitable constrictions resulting from the pattern itself.

The illustrated embodiment has the perforations in the two films positioned so that bacteria cannot pass directly from perforations 4 into perforations 4′, and as will be appreciated this requires control of the alignment of the films relative to each other so that in addition to the perforations in the two films being staggered relative to each other, the lines of laminating adhesive will be positioned so that they do not occlude perforations in the two films. This problem can be avoided by positioning the perforations in one film to one side of a pattern of laminating adhesive which serves to restrict the path through the pattern after the laminate has been formed so that its maximum dimension is not more than 15 μm, and to have perforations in the other film on the remote side of the pattern from the perforations in the first film.

1. A gas permeable polymeric film laminate comprising two perforate polymeric films bonded together such that there are gas passages between the films from perforations in one film to perforations in the other film, the perforations having a minimum dimension of at least 20 μm and the passages having a maximum dimension of not more than 15 μm.

2. A laminate according to claim 1, wherein the perforations in said films have a maximum dimension of not more than 2000 μm.

3. A laminate according to claim 1, wherein the perforations in the two films are substantially circular.

4. A laminate according to claim 3, formed using hot wires.

5. A laminate according to claim 1, wherein the two films have at least 35 perforations per m².

6. A laminate according to claim 1, wherein the said passages have a maximum dimension of not more than 10 μm.

7. A laminate according to claim 1, wherein the said passages have a minimum dimension of 5 μm.

8. A laminate according to claim 1, wherein the air flow rate therethrough is at least 10 Bendtsen.

9. A laminate according to claim 8, wherein the air flow rate therethrough is from 50 to 400 Bendtsen.

10. A package comprising a laminate according to claim 1, bonded to a substantially impermeable polymer web.
